(19) United States
(12) Patent Application Publication
(10) Pub. No.: US 2003/0056012 A1
(43) Pub. Date: Mar. 20, 2003

(54) System for providing continuous cyber link between embedded controllers and web servers

(76) Inventors: Philbert Modeste, Lewisville, TX (US); Yousri Said, Lewisville, TX (US); Mohamad Haidar, Lewisville, TX (US)

Correspondence Address: GREGORY M. LUCK, 6200 CHASE TOWER, 600 TRAVIS, HOUSTON, TX, 77002, US

(21) Appl. No.: 09/852,338

(22) Filed: May 10, 2001

(51) Int. Cl. G06F 15/16

(52) U.S. Cl. 709/249; 345/733

(57) ABSTRACT

A system is disclosed that provides a continuous cyber link connection between embedded controllers in devices installed in a home, such as digital utility meters and smart appliances, and server facilities on the World Wide Web by using a gateway with broadband connectivity to the Internet. The installed devices are interfaced in full-duplex data packet communication to the gateway through a controller. The gateway includes a translator for communication between the installed devices and a web communicator and an emulator within the gateway. The web communicator provides a link with the servers on the Web and the emulator gives a Web representation for each installed device in the user's home in the form of a personal Home Place Web Page (“MyCHome Place Web Page”). The home user has access to the installed devices in the home through the Internet using a “dot com” Web server that allows access to the Home Place Web Page (the “MyCHome Place Web Page”).

### FIELD OF THE INVENTION

The present invention relates generally to a home automation system providing a user with control access to appliances and other devices through an Internet connection. More specifically, the present invention relates to Internet control access through a web server connected to a gateway that serves as an interface between the home and the internet.

### BACKGROUND OF THE INVENTION

Various home automation control systems have been heretofore proposed. Some systems have been based upon a microprocessor-based computer controller connected by a data bus to subsystems including lighting systems, security systems, environmental sensors, home appliances, audio systems, video systems, and HVAC systems. Such systems are even accessible from a remote location over a network connection including a telephone line interface having a data modem for bidirectional transfer of control and status data. However, such systems have not combined device connectivity, home automation, home networking, and home access through the Internet in a comprehensive system. Moreover, such systems have not allowed Internet communication between different devices and different server facilities, which have their own software and database. Enhanced functionality of automation systems for 21^{st} century homes is desirable.

### SUMMARY OF THE INVENTION

The present invention affords enhanced home automation/access functionality over that of prior art systems by providing for the convergence of home automation, including device connectivity and appliance control; computer networking; and home systems access through the Internet 24 hours a day through communication with different server facilities on the World Wide Web. A continuous cyber link connection between embedded controllers in devices installed in a home, such as digital utility meters and smart appliances, and server facilities on the World Wide Web by using a gateway with broadband connectivity to the Internet. The installed devices are interfaced in full-duplex data packet communication to the gateway through a controller. The gateway includes a translator for communication between the installed devices and a web communicator and an emulator within the gateway. The web communicator provides a link with the servers on the Web and the emulator gives a Web representation for each installed device in the user's home in the form of a personal home place web page. The home user has access to the installed devices in the home through the Internet using a “dot com” Web server that allows access to the personal home place web page.

The system utilizes the gateway interface connection between the Internet and a user's home via a website that can be accessed from an Internet-connected PC or other server facilities on the World Wide Web. The gateway connection interfaces the Internet connection to a supervisory home automation controller and/or a networked home PC. The supervisory controller is in turn coupled to an assortment of devices, including programmable smart appliances and digital meters, having embedded controllers, which devices are controlled in accordance with a set of communication protocols. The gateway connection to the Internet establishes a specific IP address for the user's home. The communication protocols permit communication between the devices and server facilities accessible on the Internet.

The enhanced home access/automation functionality provided by the present invention relies upon a unique multi-communication link. By this link and via its communication protocol, a server facility on the Internet is permitted two-way communicate with a net device within the home. The link is established using a server that resides in the gateway. The gateway server includes a web communicator to identify the internet server facility and the net device. A packet of information is passed by the web communicator to a translator. After translation, the packet is sent to a controller, which in turn routes the packet to the net device. Information packets also flow through the communication link from the net device to an internet server facility.

The gateway server at the user's home provides a personal web site for the networking and home automation functionalities that obtain with respect to the home and its installed devices. Through this web site, the user can obtain personal email residing on the gateway server or on a home computer and can also gain access to files residing on the home computer. Through the web site, interactive web presence for each device installed in the home is afforded. To gain access to a device, the user can click on the device link on the web site and be sent to a page representing the device. Communication with the device then proceeds through the web site.

An additional feature of the gateway server is that meter readings from digital utility meters can be sent through to utilities companies. That is, through the gateway, the utility meters have a continuous presence on the Internet and are accessible to the utilities companies.

### BRIEF DESCRIPTION OF THE DRAWINGS

FIG. 1 is a simplified diagram of a system in accordance with the present invention and showing an overview of its general functional blocks.

FIGS. 2A and 2B are functional block diagrams of the basic hardware/software platform for implementing the system of FIG. 1.

FIG. 3 is a block diagram illustrating the constituent components of the gateway connection including the home automation and home networking aspects of the system of FIG. 1.

FIG. 4 is an illustration of an overview of the functional aspects of the controller portion of the gateway in the system of FIG. 1.

FIG. 5 is a functional block diagram of the gateway in the system of FIG. 1.

FIG. 6 is a schematic diagram for the controller hardware used in the gateway shown in FIGS. 2, 3 and 5.

FIG. 7 is a schematic diagram for the hardware used in the meters shown in FIG. 3.

FIG. 8A is an illustration of an overview of the functional aspects of the home automation controller (MC1) shown connected to the gateway in FIG. 3.

FIG. 8B is a schematic diagram of the CPU portion of the home automation controller of FIG. 8A.

FIG. 8C is a schematic diagram of the relay board portion, including the opto-isolation coupling, of the home automation controller of FIG. 8A.

FIG. 9 is a schematic diagram for the controller hardware module used in the shop device shown in FIG. 3 and connected to the gateway controller (MC2).

FIG. 10 is an illustration of the keyboard for functional user inputs and display output of the shop device of FIGS. 3 and 9.

FIG. 11 is a flowchart for the web server and website shown in FIG. 2A.

FIG. 12 illustrates the data packet format used for the communication link.

FIG. 13 is a flowchart for the web communicator functionality of the gateway connection shown in the diagram of FIG. 2.

FIG. 14 is a flowchart for the translator functionality of the gateway connection shown in the diagram of FIG. 2.

FIG. 15 is a flowchart for the emulator functionality of the gateway connection shown in the diagram of FIG. 2.

FIG. 16 is a flowchart for the engine of the gateway connection.

FIG. 17 is a flowchart of the gateway controller embedded software.

FIG. 18 is a flowchart of the net meters graphical user interface (GUI).

FIG. 19 is a flowchart of the shop device shown in FIG. 10.

FIG. 20 is a flowchart of the graphical user interface (GUI) of the shop device shown in FIG. 10.

FIG. 21 is a flowchart of the automation controller embedded software.

FIG. 22 is a flowchart of the engine for the automation controller function.

FIG. 23 is a flowchart of the gateway local graphical user interface (GUI).

FIG. 24 is a flowchart of the gateway graphical user interface (GUI) when accessed through the web server and associated web site shown in FIG. 2A.

### DETAILED DESCRIPTION

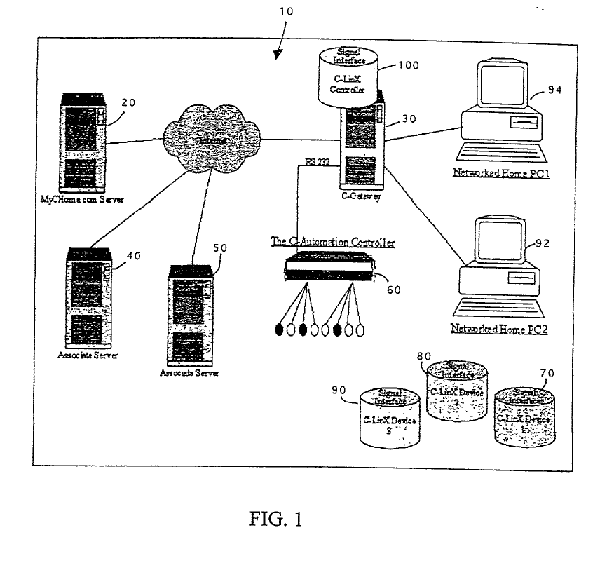

In FIG. 1, a general diagram of a system 10 in accordance with the present invention shows connection via the internet between a web site server 20 and a gateway 30 located at a user's home. Additional server facilities 40 and 50 also are connectable to gateway 30 via the internet. The gateway 30 includes broadband capability to permit Internet connectivity 24 hours a day. Through this connectivity, the system 10 realizes full automation and control of the whole house, which is accessible to home users. Each home is accessed by having a specific IP address. Such access is over an Internet connection that uses a high-speed pathway such as provided by DSL or cable. Accordingly, shown in FIG. 1 is a system for home automation control wherein a user at a remote location away from a home is provided with access to devices installed within the home through an internet connection. As used herein, the phrase “devices installed within the home” means that devices are physically located within the space of the home that includes the yard area surrounding the house or building structure. In this regard, a device installed within the home may be on the inside living area of the house or on the outside of the house structure. Further, an installed device may be either permanently or temporarily fixed relative to the house structure. Also, use of the term “home” implies not only a residential house structure such as a single family dwelling or a multi-family complex such as an apartment, townhouse or duplex living quarters, but also includes a commercial facility serving as a base of operations. That is, “home” is used in its most general sense of a habitat regardless of specific purpose as a place of domicile unless otherwise indicated.

The system of FIG. 1 combines device connectivity, home automation, home networking and home access through the internet using a home-based server and a service provider web site (MyCHome.com), which has a web page that provides a home user with access to a local web page residing on a gateway established by a home-based server. The service provider web site provides authentication and access to the local web page where all the user's personal pages and the specific pages for the installed home devices reside.

As seen in FIG. 1, the gateway 30 is coupled to networked home PCs identified as PC1 and PC2. In addition, gateway 30 is coupled over an RS 232 data link to a home automation controller 60. Various devices 70, 80 and 90 are coupled to controller 100 in gateway 30 via a wireless link such as an RF signal link or a serial/parallel data port hard-wired connection. Gateway 30 is the brain of the house. It contains a built-in broadband modem and hosts all major applications programs running to control the home. Gateway 30 also includes a built-in HUB for networking PCs together.

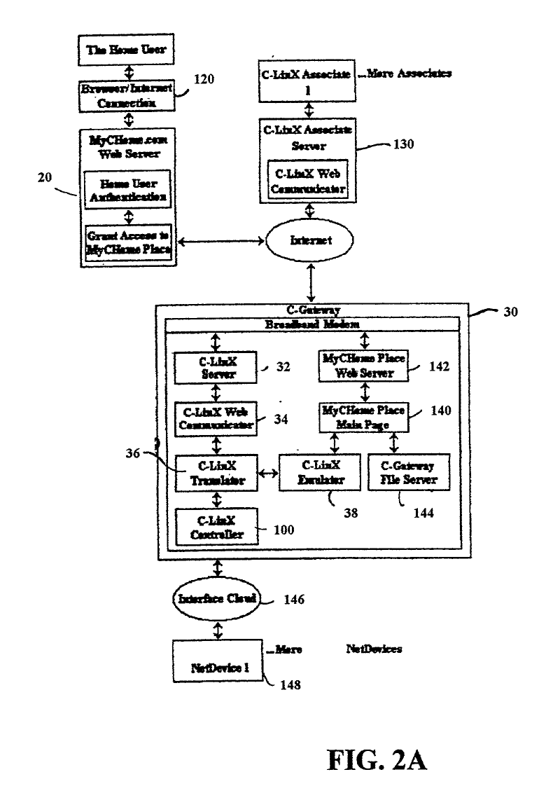

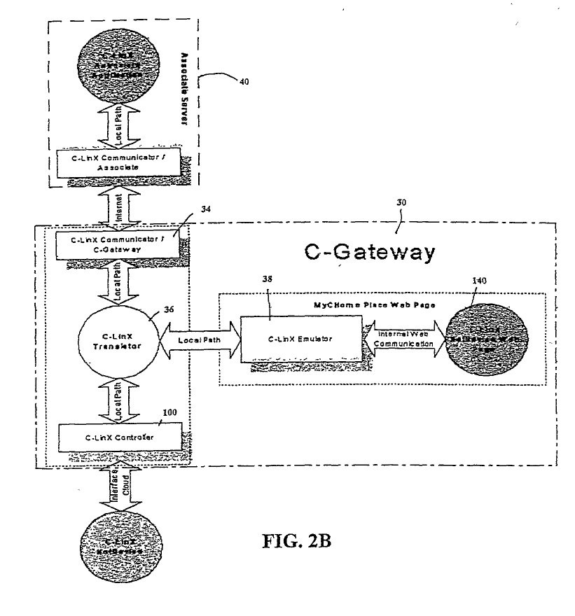

FIG. 2A shows the system of FIG. 1 in more detail as to its functional blocks. As shown, a home user operating from a remote location can obtain access to the gateway 30 resident in the home using a browser/internet connection 120 to the web server 20. Upon the user accessing the web server 20, a home user authentication/verification sequence is performed. Upon authentication, access is provided through a server internet communication link to the gateway 30. As further shown in FIG. 2A, an authorized internet server facility or “associate,” such as a business or a utility company, has access through an internet connection to the gateway 30 via a server 130 which has a compatible web communicator.

As indicated in FIG. 2A, gateway 30 has a broadband modem interface. Data packets incoming to gateway 30 are received by the server 32 and routed to the web communicator 34. A received packet is supplied to the translator 36 which decides where the packet is to be further routed. If the packet is for web page access or display, routing is to emulator 38. If the packet is for device automation control, routing is to controller 100. Via emulator 38, the user's home site web page is accessed. The site includes a main page 140 from which links can be established to other pages on the gateway web server 142 or to file server 144. If the home user is accessing one or more of the automated net devices in the home, e.g., net device 148, controller 100 effects such control using the interface cloud 146 of wireless and hard-wired connections.

FIG. 2B more precisely depicts the gateway 30 functionality in regard to the web communicator 34, translator 36 and emulator 38. Within this collection of functionalities is formed the platform that allows communication between different devices in the home and different server facilities on the internet. The web communicator 34 provides an operative full-duplex module for communication between the engine residing on the gateway and an authenticated server on the internet. The web communicator inserts and removes a security header used to authenticate any packets sent in either direction. In addition to including security data, the header further includes an address for the local gateway and device identification. The translator 36 strips away the header and evaluates the inside, target packet to determine where the packet is to be routed. Routing from the translator over local paths is to either controller 100 or to emulator 38 that provides a page display for an internal web communication link to individual net device web pages. The emulator takes specific net device data from the translator and presents it to a specific page for that net device within the main page. The web communicator, translator and emulator functionalities permit a home user to log in through a general access web page (MyCHome.com) and gain access to his home's local web page (MyCHome Place web page). From there, the user can go to any net device or appliance page.

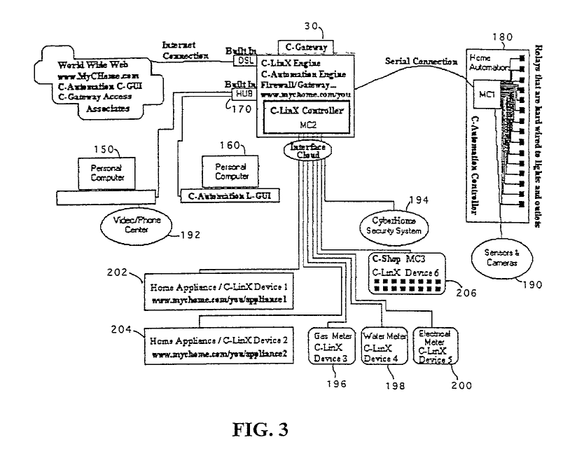

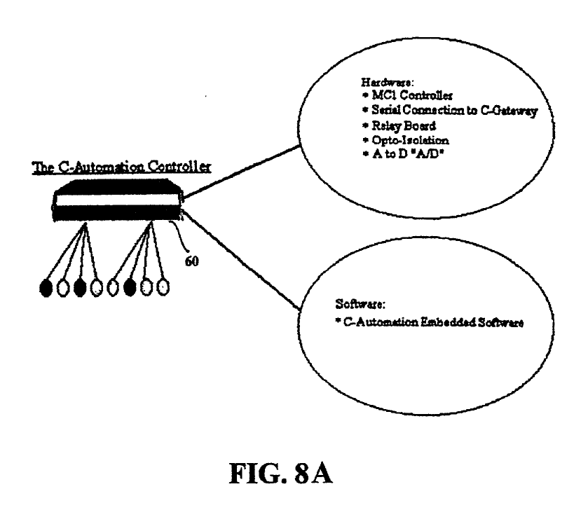

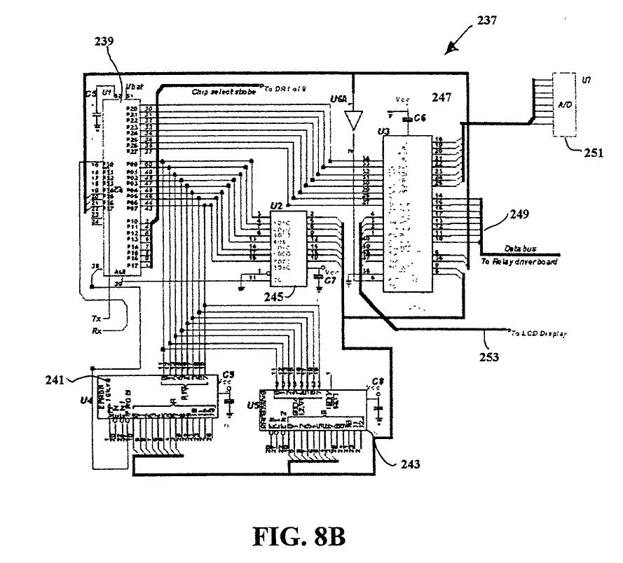

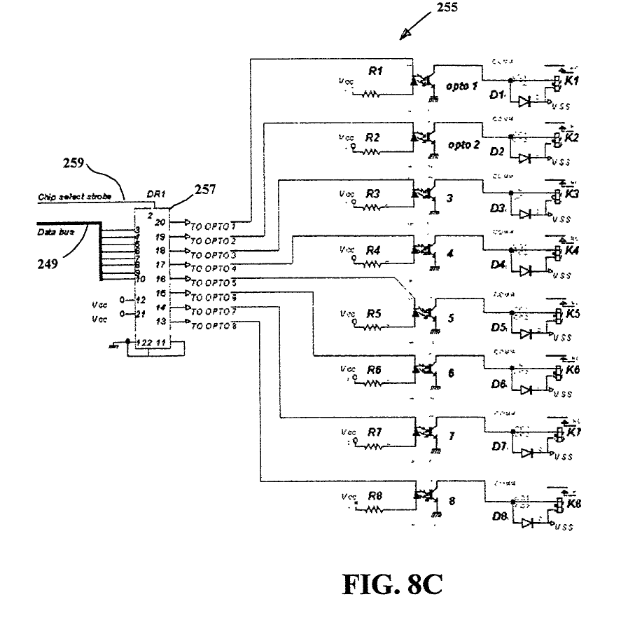

In FIG. 3, the various connections within the home to the gateway are diagrammed. As indicated, personal computers 150 and 160 connected over a HUB 170 to provide home networking can be connected to gateway 30. From the gateway server functionality, home automation is provided by an automation controller (MC1) 180 serially connected to the gateway. The automation controller is further diagrammed in FIG. 8. The hardware of the automation controller includes a serial connection, a controller card, a relay board, and opto-isolation circuitry for protection of the board. Additional home control devices connectable to the gateway 30 via the automation controller 180 include sensors and cameras 190. A video/phone center 192 can be connected via a networked PC. A home security system 194 can be connected via controller MC2 using the interface cloud. Control of home appliances and net devices is also provided by controller MC2. Various net devices to be accessed and controlled include a gas meter 196, a water meter 198, and an electrical meter 200. The appliances controlled can be of many different varieties including “smart” kitchen appliances such as refrigerators, ovens, HVAC units, and the like. Each such device, such as devices 202 and 204 identified as home appliance automation 1 and home appliance automation 2 can be controlled through a separate sub-page accessed through the main web page (e.g., My Chome.com/you/appliance1 and My Chome.com/you/appliance2). Finally, a home shopping function is available as the C-shop 206 as well as other web services 208.

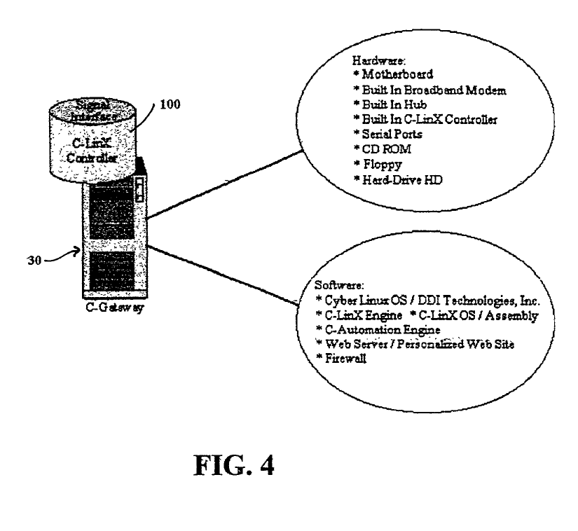

The gateway 30 hardware as indicated in FIG. 4 has several built-in components. These components include a broadband modem, a HUB, the controller, various serial ports, a CD ROM drive, hard drive, and a floppy drive. The software generally includes an operating system, engines for data handling and automation, a web server including a personalized web site, and a firewall.

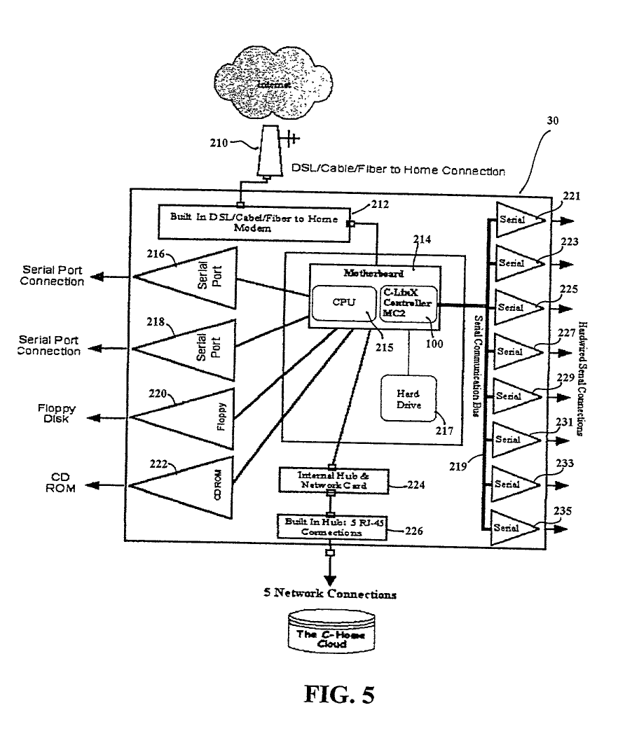

The built-in components of gateway 30 are further diagrammed in FIG. 5. As shown, a DSL or Cable or Fiber Optic connection 210 between the home and the internet is used. The broadband modem 212 couples the connection to a motherboard 214 having a CPU 215 and the controller 100 (MC2). Connections are made to serial ports 216 and 218 as well as Floppy Disk 220, CD ROM 222 and Hard Drive 217. A further connection is made to an internal HUB and network card 224 and multiple RJ-45 connections 226 which provide multiple network connections within the home. A serial data bus 219 couples to hardwired serial connections 221, 223, 225, 227, 229, 231, 233, and 235.

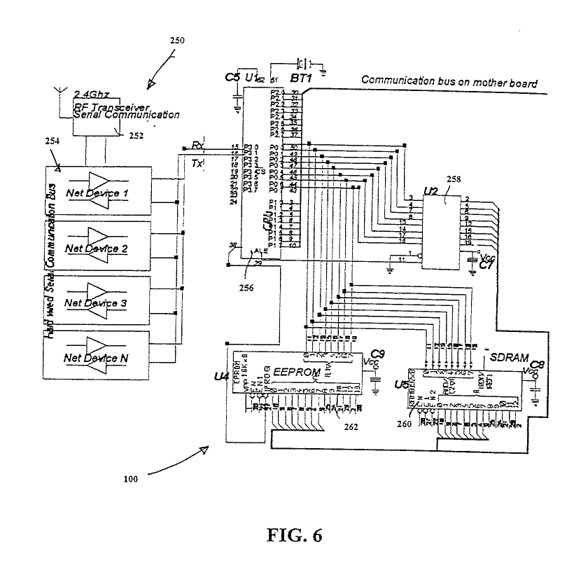

Turning to FIG. 6, a schematic diagram of the circuitry for controller 100 in gateway 30 is provided. The controller includes a multi-protocol transceiver interface 250. The interface includes an RF transceiver 252 connected to a hardwired serial communication bus 254, which also connects to net devices 1 through N. The transceiver interface is coupled to a CPU 256 that is in turn coupled to a communication bus on the gateway motherboard. External memory devices including SDRAM 260 storing user data and EEPROM 262 for storing program code are coupled to the CPU by an address latch 258 that provides for program/data flow control. The CPU receives data from the transceiver and processes it to determine its origin and type. The CPU then sends the processed data to the motherboard.

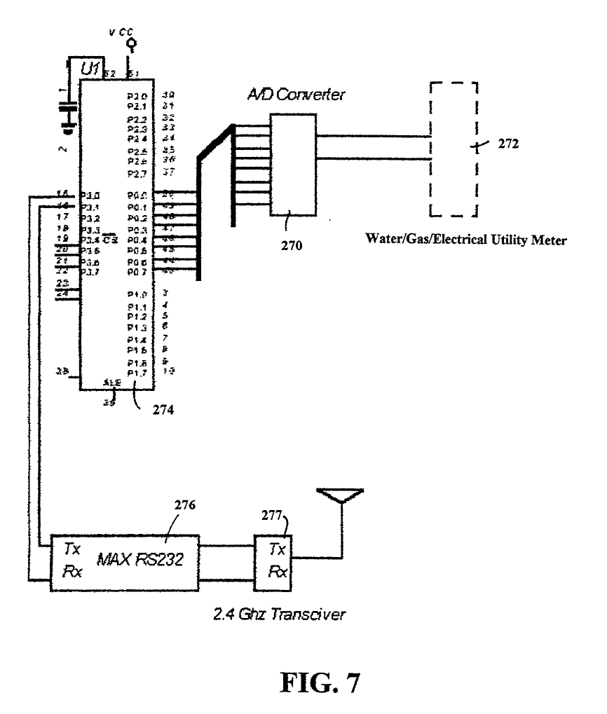

Shown in FIG. 7 is the schematic circuit diagram for the controller resident in each of the meter devices 196, 198 and 200 of FIG. 3. The controller includes a 12-bit analog-to-digital (A/D) converter 270 that reads the meter transducer 272 and provides an output to CPU 274. The CPU is coupled to a transceiver 276. The CPU processes the incoming data from the A/D converter and puts it on a serial bus for transmission through the serial interface 276 and transceiver 277.

In FIG. 8, the automation controller 60 components are identified. The controller board 237 is shown in FIG. 8A. The controller board includes CPU 239, which runs the real time operating system. The controller board is connected to gateway 30 over a serial RS232 interface as indicated in FIGS. 1 and 3. Specifically, CPU 239 receives data from gateway 30 and tests it for authenticity. If the data is valid, the appropriate control action is executed. A memory 241 coupled to CPU 239 stores external program code over 16 KB. Similarly, a memory 243 coupled to CPU 239 stores external user data over 1 KB. Latch 245 interfaces the outputs of memories 241 and 243 to CPU 239 and provides for program/data flow control between the memories and the CPU. In addition, I/O port device 247 is coupled to the CPU through latch 245. I/O port device 247 interfaces the controller board to the external devices such as switched installed home devices. The I/O port device 247 couples to data bus 249 that extends to the relay driver board shown in FIG. 8C. For reading sensor data, an analog-to-digital converter (ADC) 251 is provided. Also provided is a bus 253 for supplying data to an LCD Display (not shown).

The relay board 255 in FIG. 8C has eight (8) relay channels identified as K1 through K8. A latch driver 257 couples to bus 249, which extends from the controller board 237 of FIG. 8B. Data from CPU 239 causes one of the opto-isolators, which are identified as OPTO 1 through OPTO 8, to be selected when the chip select strobe line 259 is activated by the CPU. Each of the opto-isolators comprises a light emitting diode (LED) optically coupled to a phototransistor. When selected, the opto-isolator operates to trigger its associated relay (K1 through K8). This is achieved by latch 257 sinking current through the resistor and diode circuit of the opto-isolator. Current flow through the LED activates the phototransistor switch that is in series with the relay coil. Accordingly, current flow through the relay coil and causes the relay contacts, which are in a control circuit for an installed switched home device, to close and thereby activate the installed switched home device.

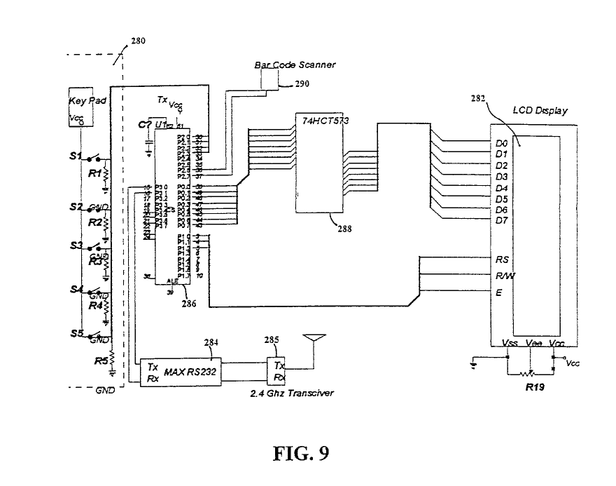

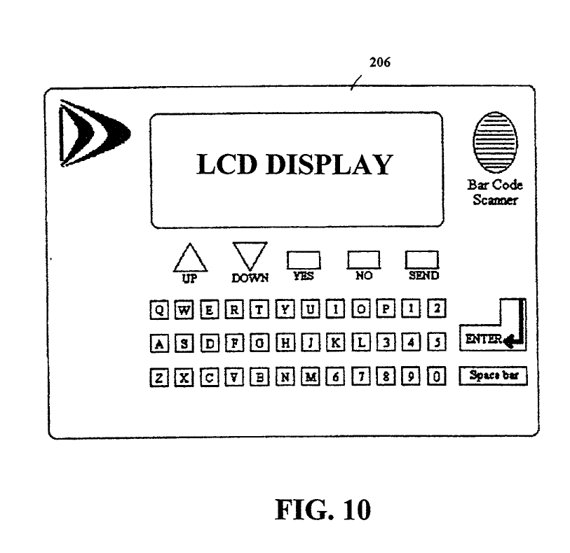

The C-shop device 206 shown in FIG. 3 is a hardware module that connects to controller 100 as a separate channel and provides a home user with online shopping capability. The module is programmed with an online shopping company's database. Following prompts, a user is able to place an order for merchandise that is automatically sent through gateway 30 to the server of the online shopping company. Product updates, order updates and sales information is accessible to the home user. The online shopping company will identify the home user by the IP address of that home. As seen in FIGS. 9 and 10, the module includes a TFT display and a keyboard.

In FIG. 9, a schematic diagram of the circuitry for device 206 indicates that the keyboard 280 has a number of push buttons. S1 (“the UP button”) and S2 (“the DOWN button”) permit a user input to allow a person to browse a list of items. S3 (“the YES button”) is used to select an item. Each time S3 is depressed, the item on the display 282 is added to the list. S4 (“the NO button”) is used to decline an option. S5 is the SEND button. Upon pressing S5, the data is placed on the serial bus and provided to serial interface 284 and transceiver 285 in submission of an order. The CPU 286 executes the shopping control program and stores the data. An address latch 288 is provided to control the flow of data to the display 282. Also included and coupled to CPU 286 is bar code scanner 290.

With the above description, it will be appreciated that the system adopts a protocol that allows communication between different devices in the home and different Internet facilities. The gateway has its own IP address and each device has its own sub-address that is a local ID. Devices have a full path of communication with a particular Internet facility having dedicated software and a database on the Internet. The gateway controller is the Hub that allows home devices and appliances to communicate with the Internet facilities. The gateway engine provides the local connectivity software for communications with the controller and with the Internet facilities. The engine stamps each packet of information with the specific ID that represents a specific device. The packet is then sent through the internet to the IP address of the associated Internet facility.

The gateway 30 supports three types of connections: a continuous input link, an interrogated link, and a raw data link. Continuous input links are used where the data being received by the controller is constant such as the reading of temperature from a sensor. An interrogated link is one where a sampling is made of one or more devices on a timed or interval basis such as the reading of a water or electrical meter. A raw data connection is used to send or receive data with a device using raw data packets such as a data exchange between the gateway and an Internet shopping site.

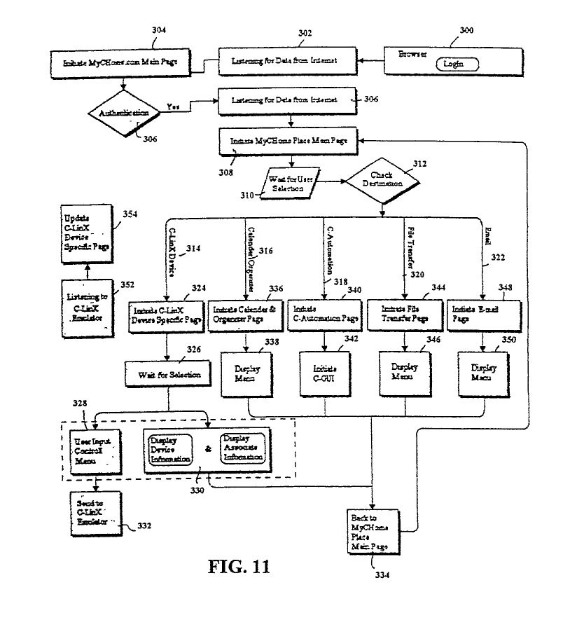

A flowchart for the web server 20 and web site is shown in FIG. 11. From a browser log-in 300 a user gains access to web server listening for a user log-in at block 302. Once the main page 304 is accessed, an authentication operation 306 is executed. If the authentication indicates a valid user, the web server begins listening for data coming in over the internet connection at block 306. The web server also provides the user with a connection to his personal home main page at block 308, which resides on gateway 30. The gateway waits for user selection of information at block 310. When data is received, the destination is checked at block 312 before routing to one of the paths 314, 316, 318, 320 or 322.

If the destination is path 314 for a device, a device specific page 324 is accessed. Following access to page 324, the system waits at block 326 for a selection to be made at block 326. The selection can be either to a user input control menu 328 or to a device information display function at block 330. From the user input control menu, data is sent to the gateway emulator 332. From the device display, user is sent back through block 334 to the main page at block 308.

If the destination is path 316, a calendar and organizer page is initiated at block 336 which provides a display menu at block 338. If the destination is path 318, the automation page is brought up at block 340 and a GUI 342 is provided at block 342. If the destination is path 320, a file transfer page is initiated at block 344, which also brings up a display menu at block 346. Finally, if the destination is path 322, an email page is initiated at block 348 and a display menu is provided at block 350. From the display menus 338, 346, and 350 or from GUI 342, routing is through block 334 back to the main page at block 308.

To be noted also is that a listening function by the gateway emulator is also being executed at block 352. This provides a mechanism for updating a device specific page at block 354.

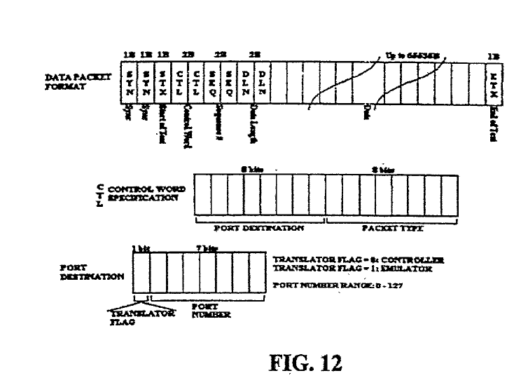

Information between the gateway and the installed home devices is in accordance with a defined protocol. In accordance with that protocol, data is sent to and from the installed home devices and the gateway. Also, the protocol establishes communication between the major components of the gateway. Moreover, the protocol permits application developers to use the protocol as a base for applications to interface with and control installed home devices over the Internet. Information communication transfers within the system of FIG. 1 are made on the basis of packets. The data packet format is shown in FIG. 12. The data packet includes packet header information and data. The header information includes line control bytes, sync bytes, start of text byte, control words, and a sequence number. The control word is two bytes in length. The first byte controls the port number of an installed home device where data is to be routed. The most significant bit is used as a “flag” bit to indicate physical ports controlled by the controller or logical ports controlled by the gateway emulator. The second byte of the control word is used to identify the type of packet from among the various predetermined packet types. Several packet types are reserved for future use by, for example, Web application developers, which packet types can be defined and used as needed. The various types of packets are indicated in the following table.

| Hex | Binary | |
|---|---|---|
| Value: | Value: | Packet Type: |
| 16 H | 000010110 | Raw Data |
| 17 H | 000010111 | Heart Beat Request |
| 18 H | 000011000 | Heart Beat Response |
| 19 H | 000011001 | MC2 Port Sample Rate “0-3 B H, 0-3 B H” “Minutes, Hours” |
| 20 H | 000100000 | MC2 Port Sending Rate “0-3 B H, 0-3 B H, 0-FF H” “Minutes, |
| | | Hours, Days” |
| 21 H | 000100001 | Reserved for C-Meters |
| 22 H | 000100010 | Reserved for C-Meters |
| 23 H | 000100011 | Reserved for C-Shop Commands |
| 24 H | 000100100 | Reserved for C-Shop Commands |
| 25 H | 000100101 | Reserved for future use |
| 26 H | 000100110 | Reserved for future use |
| 27 H | 000100111 | Reserved for future use |
| 28 H | 000101000 | Reserved for future use |
| 29 H | 000101001 | Reserved for future use |
| 30 H | 000110000 | Reserved for future use |
| 31 H | 000110001 | Reserved for future use |
| 32 H | 000110010 | Reserved for future use |
| . . . | . . . | Reserved for future use |
| 1FF H | 111111111 | Reserved for future use |

Heartbeat packets originate from the gateway to the MC2. The heartbeat packet contains no data so the data length fields are zero length. The timing between heartbeat packets is determined by configuration data in the gateway. An example would be the gateway sending a heartbeat packet once every fifteen seconds. The gateway would allow five seconds to receive a response to heartbeat packet. The following is a heartbeat packet:

| SYN | SYN | STX | CTL | CTL | SEQ | SEQ | DLN | DLN | ETX |
|---|---|---|---|---|---|---|---|---|---|
| 16 | 16 | 02 | 00 | 17 | 00 | 02 | 00 | 00 | 03 |

The following is a heartbeat response packet:

| SYN | SYN | STX | CTL | CTL | SEQ | SEQ | DLN | DLN | ETX |
|---|---|---|---|---|---|---|---|---|---|
| 16 | 16 | 02 | 00 | 18 | 00 | 02 | 00 | 00 | 03 |

The following is a raw data packet with 45 (hex) bytes of data. The sequence number is always even when the data originates from the gateway. For each packet, the sequence number will increment.

| SYN | SYN | STX | CTL | CTL | SEQ | SEQ | DLN | DLN | DATA | *** | DATA | ETX |
|---|---|---|---|---|---|---|---|---|---|---|---|---|
| 16 | 16 | 02 | 00 | 16 | 00 | 02 | 00 | 00 | | | | 03 |

The following is a raw data acknowledge packet. The acknowledgement packet will have the same sequence number but a zero data length.

| SYN | SYN | STX | CTL | CTL | SEQ | SEQ | DLN | DLN | ETX |
|---|---|---|---|---|---|---|---|---|---|
| 16 | 16 | 02 | 00 | 16 | 00 | 02 | 00 | 00 | 03 |

The following is a raw data no acknowledgement packet (packet type 15). The packet will have the same sequence number but a data length of zero.

| SYN | SYN | STX | CTL | CTL | SEQ | SEQ | DLN | DLN | ETX |
|---|---|---|---|---|---|---|---|---|---|
| 16 | 16 | 02 | 00 | 15 | 00 | 02 | 00 | 00 | 03 |

The following is an example of raw data exchanges with acknowledgements. The sequence number is 0004 and the data length is 0068 (hex) bytes of data.

| SYN | SYN | STX | CTL | CTL | SEQ | SEQ | DLN | DLN | DATA | *** | DATA | ETX |
|---|---|---|---|---|---|---|---|---|---|---|---|---|
| 16 | 16 | 02 | 00 | 16 | 00 | 04 | 00 | 68 | | | | 03 |

The following is a raw data acknowledge packet. The acknowledgement packet will have the same sequence number but a zero data length.

| SYN | SYN | STX | CTL | CTL | SEQ | SEQ | DLN | DLN | ETX |
|---|---|---|---|---|---|---|---|---|---|
| 16 | 16 | 02 | 00 | 16 | 00 | 04 | 00 | 00 | 03 |

The next raw data packet has a sequence number of 0006 with a data length of 0072 (hex) bytes of data.

| SYN | SYN | STX | CTL | CTL | SEQ | SEQ | DLN | DLN | DATA | *** | DATA | ETX |
|---|---|---|---|---|---|---|---|---|---|---|---|---|
| 16 | 16 | 02 | 00 | 16 | 00 | 06 | 00 | 72 | | | | 03 |

The acknowledgement packet with sequence number of 0006 and data length of 00 would be as follows:

| SYN | SYN | STX | CTL | CTL | SEQ | SEQ | DLN | DLN | ETX |
|---|---|---|---|---|---|---|---|---|---|
| 16 | 16 | 02 | 00 | 16 | 00 | 06 | 00 | 00 | 03 |

The next raw data packet has a sequence number of 0008 and a data length of 25AB (hex) bytes of data.

| SYN | SYN | STX | CTL | CTL | SEQ | SEQ | DLN | DLN | DATA | *** | DATA | ETX |
|---|---|---|---|---|---|---|---|---|---|---|---|---|
| 16 | 16 | 02 | 00 | 16 | 00 | 08 | 25 | AB | | | | 03 |

A raw data acknowledge packet will have the same sequence number but a zero data length.

| S | S | S | C | C | S | S | D | D | E |
|---|---|---|---|---|---|---|---|---|---|
| Y | Y | T | T | T | E | E | L | L | T |
| N | N | X | L | L | Q | Q | N | N | X |
| 16 | 16 | 02 | 00 | 16 | 00 | 08 | 00 | 00 | 03 |

The next raw data packet has a sequence number of 000A and a data length of 34C3 (hex) bytes of data.

| | | | | | | | | | D | | D | |
|---|---|---|---|---|---|---|---|---|---|---|---|---|
| S | S | S | C | C | S | S | D | D | A | | A | E |
| Y | Y | T | T | T | E | E | L | L | T | ** | T | T |
| N | N | X | L | L | Q | Q | N | N | A | * | A | X |
| 16 | 16 | 02 | 00 | 16 | 00 | 0 | 34 | C | | | | 03 |
| | | | | | | A | | 3 | | | | |

| S | S | S | C | C | S | S | D | D | E |
|---|---|---|---|---|---|---|---|---|---|
| Y | Y | T | T | T | E | E | L | L | T |
| N | N | X | L | L | Q | Q | N | N | X |
| 16 | 16 | 02 | 00 | 16 | 00 | 0 | 00 | 00 | 03 |
| | | | | | | A | | | |

When the sequence number reaches the limit, it will “wrap” and start over at 0002.

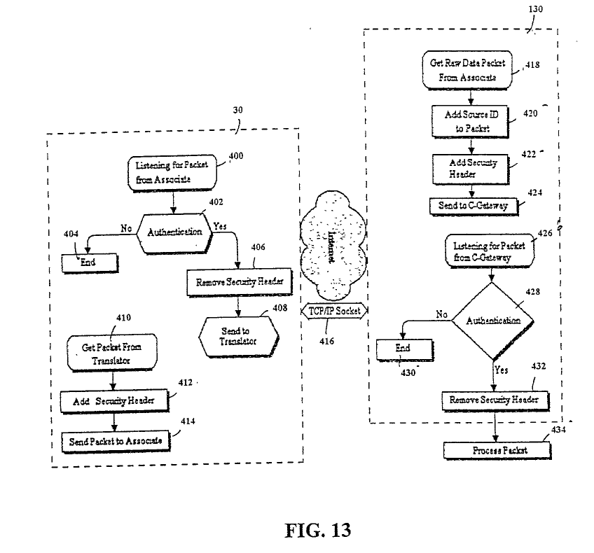

Turning now to FIG. 13, a flowchart of the gateway web communicator 34 (FIG. 2A) is shown to begin with an operation of listening for a data packet at block 400. Upon receipt of an incoming packet, authentication is made at block 402. If authentication fails, the operation ends at block 404. When authentication is confirmed, the operation proceeds to block 406 where the security header is removed and the packet is sent to the translator at block 408. For an out-going packet, the packet is obtained from the translator at block 410 and a security header is added at block 412. The packet is then sent at block 414 to a server facility on the internet. Communication between the gateway and an internet server facility are through a TCP/IP socket 416.

At an internet server facility 130 (FIG. 2A) that is sending data to the gateway 30, a raw data packet is obtained at block 418. A source ID is added at block 420 and a security header is added at block 422 before sending the packet to the gateway at block 424. The internet server facility also listens for a packet coming from the gateway at block 426. Upon receipt of a packet, authentication is executed at block 428. If authentication fails, the operation ends at block 430. If authentication is confirmed, the security header is removed at block 432 and the packet is processed at block 434.

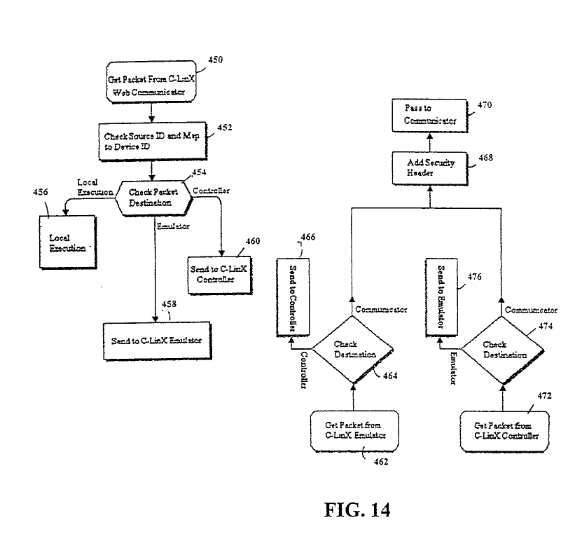

In FIG. 14, a flowchart for the translator 36 (FIG. 2A). The translator makes a decision on each packet received from the web communicator 34. At block 450, a packet is obtained from the web communicator. A check is made as to the source ID and a map to a device ID is created at block 452 whereupon a check is made for packet destination at block 454. As indicated, routing could be to block 456 for local execution, to emulator 38 at block 458, or to controller 100 at block 460. The translator also listens to data packets coming from the emulator. At block 462, a packet is obtained from the emulator. A check is made at block 464 for the destination, which can be to either the controller at block 466 or to the web communicator. Packets sent to the web communicator have a security header added at block 468 before being passed at block 470 to the web communicator. The translator yet further accepts data packets from the controller at block 472. Again, a check is made for the destination at block 474, which can be either the emulator at block 476 or the web communicator through blocks 468 and 470.

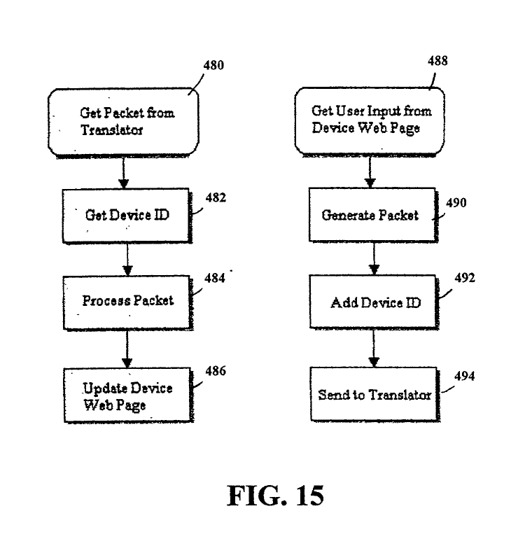

FIG. 15 is a flowchart for emulator 38 (FIG. 2A). The emulator is a function embedded in the web page of the gateway. The emulator provides for information coming from the translator to be displayed. Information messages could originate in the controller or from the web communicator. The emulator facilitates user control of devices through the internet and defines a full duplex communication. A packet is received from the translator at block 480. Then, a device ID is obtained at block 482 before processing of the packet at block 484. The web page is thereafter updated at block 486. For information transfer to the translator, a user input is obtained from the device web page at block 488. A packet is generated at block 490 and a device ID is added at block 492. The packet is then sent to the translator at block 494.

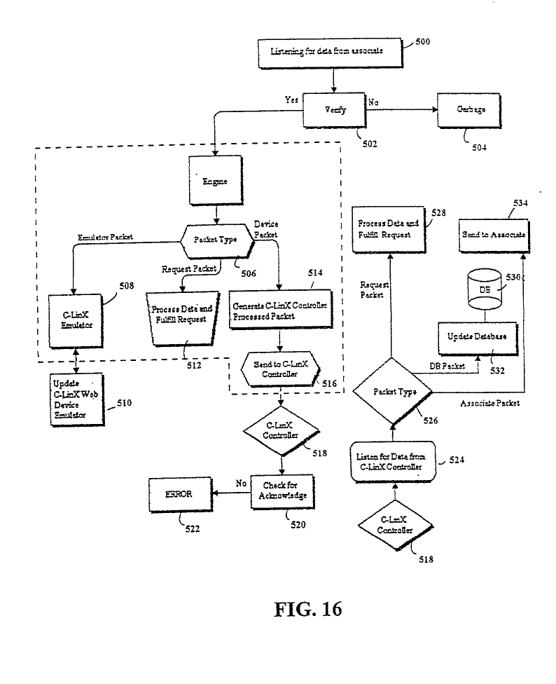

In FIG. 16, a flowchart for the gateway engine is provided. The gateway listens for data from an internet server facility at block 500 and is verified at block 502. Verified data is routed to the engine. Unverified data is sent to the garbage at block 504. At the engine, a data packet is identified as to type at block 506. An emulator packet is sent to the emulator 508 and the device update is accomplished at block 510. A request packet is sent to block 512 where data is processed and the request fulfilled. A device packet is sent to block 514 where a controller processed packet is generated. The processed packet is sent to the controller at block 516. At controller block 518, the packet is presented to block 520 to be checked for an acknowledgement. If there is no acknowledgement, the packet is deemed to be an error at block 522. A packet from the controller at block 518 is identified by block 524, which listens for data from the controller. The packet type is assigned at block 526. A request packet is processed and fulfilled at block 528. A database DB packet is routed to the update the database 530 at block 532. A packet to be sent to an internet server facility is routed through block 534.

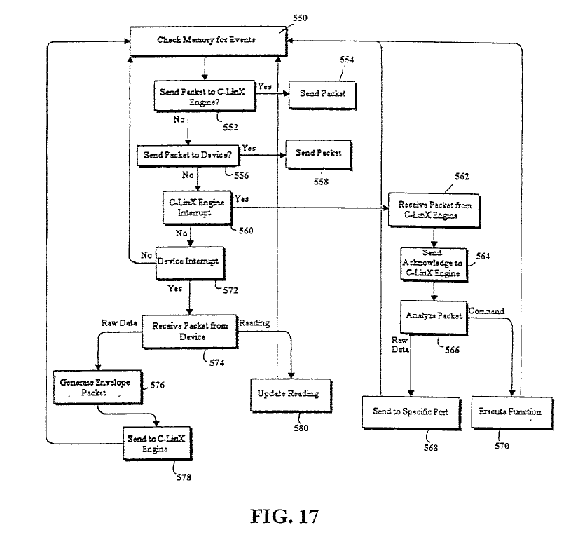

In FIG. 17, a flowchart for the controller embedded software is presented. The routine begins at block 550 with a memory check. Next, an inquiry is made at block 552 as to whether to send a packet to the gateway engine. If so, a packet is sent at block 554. If not, an inquiry is made at block 556 as to whether to send a packet to a device. If so, a packet is sent at block 558. If not, a check is made at block 560 for an engine interrupt. When an engine interrupt occurs, the program branches to block 562 to receive a packet from the engine. An acknowledgment is sent to the engine at block 564 and the packet is analyzed at block 566. Raw data is sent to a specific port at block 568 or a command is sent to execute a function at block 570. If there is no engine interrupt, a check is made for a device interrupt at block 572. If there is no device interrupt, the program branches back to block 550. If there is an interrupt, a packet is received from the device at block 574. Raw data is routed to block 576 where a packet envelope is generated. The packet is sent to the engine at block 578 and the program returns to block 550. If the operation is to read the device, the reading is updated at block 580 and then a return is made to block 550.

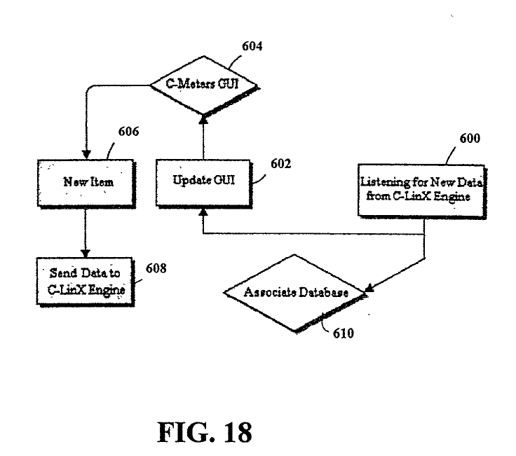

FIG. 18 provides the flowchart for the meters GUI. At block 600, the engine listens for new data. Routing is then to block 602 to update the GUI. The updated meter GUI at block 604 is identified as a new item at block 606 and is sent to the engine at block 608. Also, from block 600, new data can be sent to a database at block 610.

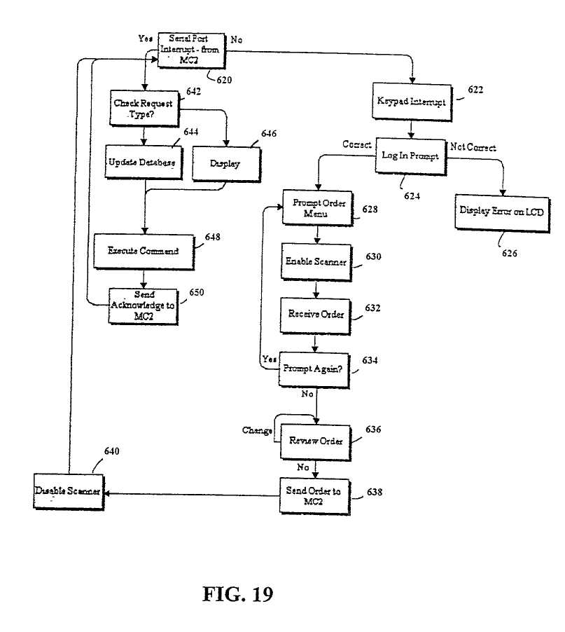

A flowchart of the shopping embedded software is shown in FIG. 19. A serial port interrupt from controller MC2 is evaluated at block 620. If there is no interrupt from MC2, an evaluation is made at block 622 as to a keyboard interrupt. If a log-in prompt is not correct, an error display is put on the LCD at block 626. If the log-in prompt is correct, an order menu is called at block 628, the scanner is enabled at block 630, an order is input at block 632. At block 634, a determination is made as to whether another prompt is needed. If so, a return is made to block 628. If not, the program proceeds to block 636 where the order is reviewed and changes can be made. Then, the order is sent to MC2 at block 638. An instruction to disable the scanner is issued at block 640 and the program returns to block 620. If an interrupt is received from MC2, a check is made at block 642 as to the type of request. From there, a database is updated at block 644 and a display is made at block 646. A command is executed at block 648 and an acknowledgement is sent to MC2 at block 650.

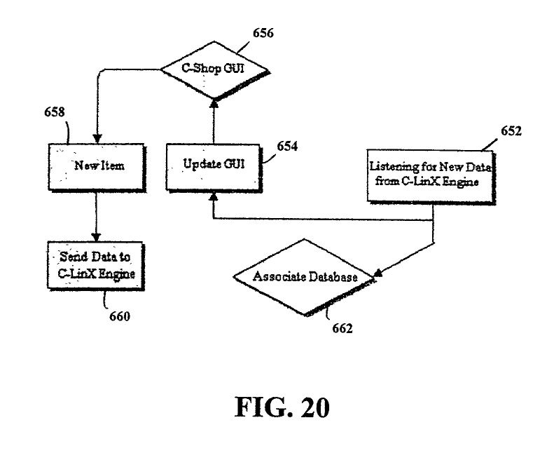

A flowchart of the shop GUI is shown in FIG. 20. This GUI is similar to the meter GUI. At block 652, the engine listens for new data. Routing is then to block 654 to update the GUI. The updated meter GUI at block 656 is identified as a new item at block 658 and is sent to the engine at block 660. Also, from block 652, new data can be sent to a database at block 662.

The automation functionality provided by the automation controller 60 of FIG. 8A allows a home user to control such things as lights and electrical outlets by dimming or on/off switching. The automation functionality may also schedule timed or sequenced events. Further, sensor inputs can be read such as temperature sensors and the like. The automation functions can be manipulated by the home user by a local graphical user interface (Local GUI) that resides on a local computer within a home local area network (LAN). The Local GUI is accessed by the home user to program the automation controller and to read any sensors. The home user can also access the automation functionality of the system through a second, auxiliary GUI that resides on a web server. After logging in and being authenticated, the home user can access the same automation functions as are accessible through the Local GUI. The automation controller (MC1) communicates serially with and receives packets of information from the gateway engine.

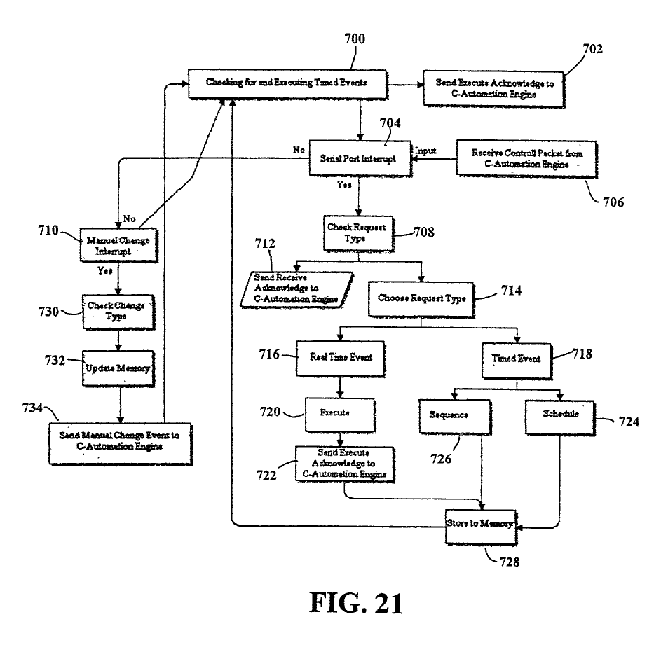

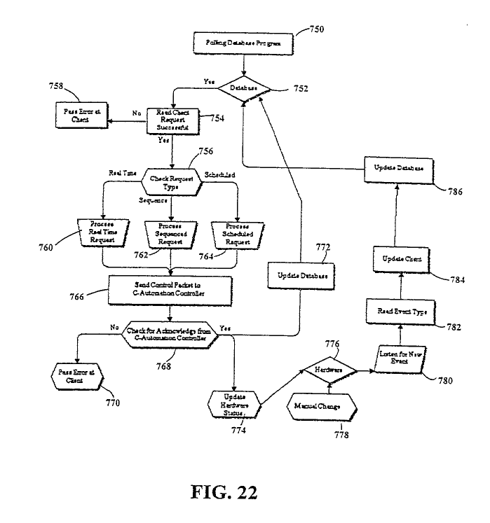

In FIG. 21, a flowchart of the automation controller embedded software is presented. This software checks for and executes timed events at block 700. At block 702, an execute acknowledgement command is sent to the automation engine (FIG. 22). At block 704, a serial port interrupt is checked. If an interrupt is received from the automation engine at block 706, a check of the request is made at block 708. If there is no interrupt, a check is made for a manual interrupt at block 710. If there is none, a return is made to block 700. At the end of checking the request, an acknowledgement is sent to the automation engine at block 712. Also, a request type is chosen at block 714. A branching takes place to either a real time event at block 716 or a timed event at block 718. A real time event is executed at block 720 and an acknowledgement is sent to the automation engine at block 722. A timed event is scheduled at block 724 or a sequence is established at block 726. At the conclusion of each type of request, there is a store to memory at block 728 followed by a return to block 700. In the event that there is a manual interrupt at block 710, a check of the change type is made at block 730 followed by updating of the memory at block 732. Thereafter, a manual change is sent to the automation engine at block 734 followed by a return to block 700.

A flowchart of the automation engine is shown in FIG. 22. The automation engine polls the database program 752 at block 750. If there is a client request, the request is read at block 754. If the request has been successfully read, a check is made of the request type at block 756. If the request has not been successfully read, an error is noted at block 758. The type of request can be a real time request, a sequence request, or a scheduled request. Each is separately processed in a respective block 760, 762 or 764. Thereafter, a control packet is sent to the automation controller at block 766 and a check is made at block 768 for receipt of an acknowledgement from the automation controller. If an acknowledgement is not received, an error is noted at block 770. If an acknowledgement is received, the database 752 is updated at block 772. Also, an update to the hardware 776 status is made at block 774. A manual change to hardware 776 is also possible at block 778. After a hardware change, listening for a new event begins at block 780. A new event type is read at block 782 and the client is updated at block 784 which leads to updating database 752 at block 786.

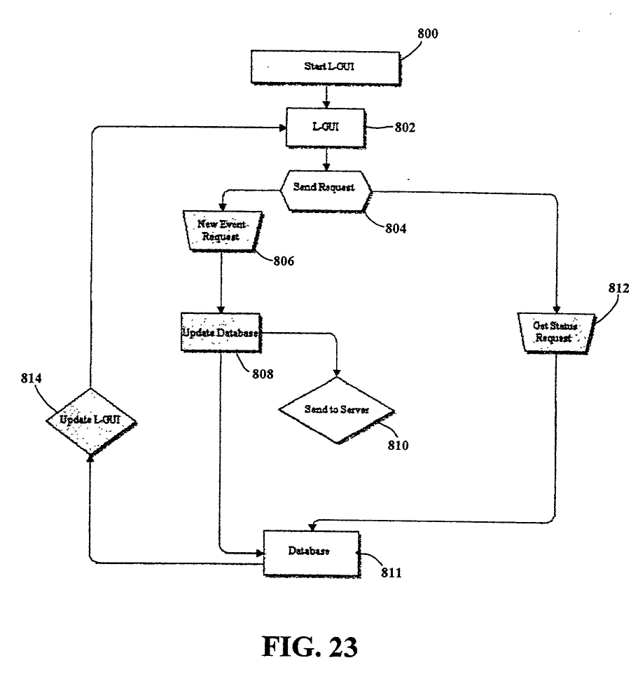

In FIG. 23, a flowchart for a local graphical user interface (L-GUI) residing at the gateway 30 for the automation functionality provided through automation controller 60 is presented. The L-GUI is started at block 800 and accessed at block 802. A request is sent at block 804. A new request initiated at block 806 updates the database at block 808. The update is sent to a server at block 810. A request to get a status from the database is processed at block 812. After either operation, the L-GUI is updated from the database at block 814.

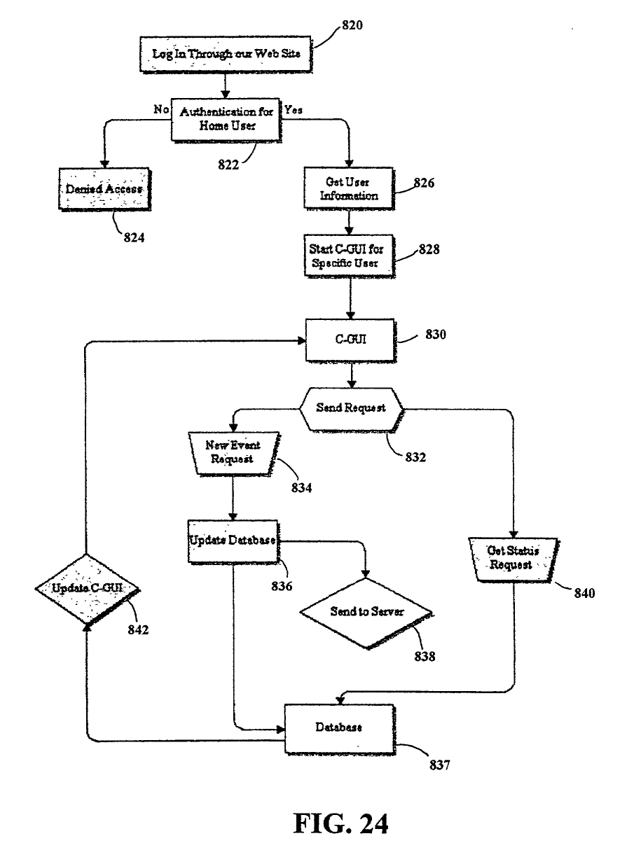

In FIG. 24, a flowchart for a graphical user interface residing on the web server that communicates with the gateway (C-GUI) and provides for the automation functionality of automation controller 60 is presented. First, a user logs in at block 820. After authentication at block 822, either access is denied at block 824 or access is given to user information at block 826. The C-GUI is started for the specific user at block 828. From the C-GUI at block 830, a request is sent at block 832 in a similar fashion to the L-GUI of FIG. 23. That is, a new request initiated at block 834 updates the database 837 at block 836. The update is sent to a server at block 838. A request to get a status from the database is processed at block 840. After either operation, the C-GUI is updated from the database at block 842.

From the foregoing description, the system consists of software, hardware, and protocols that allow communication between devices inside the home and servers on the Internet for specific facilities with specific IP addresses. A web server has an IP address through which broadband connectivity to a home gateway server. A homeowner is allowed to log-in through a web site and communicate over the Internet with the devices and appliances installed within or about the home. Each device has its own page within the homeowner's web site. Automation includes software, hardware and protocols that allow full automation of sensor readings and data acquisition. Also, the web site allows the homeowner to log-in and communicate with the automation function through full control and reading of real time data and events. The system described is particularly suited for digital utility meters in the home that send meter readings through the system to utilities companies by providing total access to the meters over the internet.

Although specific embodiments of the invention have been set forth herein in some detail, it is understood that this has been done for the purposes of illustration only and is not to be taken as a limitation on the scope of the invention as defined in the appended claims. It is to be understood that various alterations, substitutions, and modifications may be made to the embodiment described herein without departing from the spirit and scope of the invention as set forth in the appended claims.

What is claimed is:

1. A system for home automation control wherein a user at a remote location away from a home is provided with access to devices installed within the home through an internet connection, comprising:
a browser internet connection to a first web server having an associated first web site with a main page providing a home automation graphical user interface (GUI) identifying home automation control functions;
a gateway at the home communicating with the first web server, the gateway including a second web server having an associated second web site with a main page including links to additional second web site pages;
one or more home devices for providing home automation control functions within the home, each home device having an associated device page provided as an additional second web site page selectable and accessible from the second web site main page; and
a controller interfaced to the gateway and coupled to the home devices for bidirectional communication therebetween, the controller routing an information packet between the gateway and a home device in accordance with a selection made by a user through the home automation GUI of the first web site and the main page of the second web site.

2. The system of claim 1 wherein the home device is a smart appliance.

3. The system of claim 1 wherein the home device is a digital utility meter.

4. The system of claim 3 wherein the communication link between the controller and the gateway is an interrogated connection type involving access to a digital utility meter on an interval basis.

5. A system for home automation control wherein a user at a remote location away from a home is provided with access to devices installed within the home through an internet connection, comprising:
a browser internet connection to a first web server having an associated first web site with a main page providing a home automation graphical user interface (GUI) identifying home automation control functions;
a gateway at the home communicating with the first web server, the gateway including a second web server having an associated second web site with a main page including links to additional second web site pages;
one or more smart home devices for providing home automation control functions within the home based upon digital input control data, each smart home device having an associated device page provided as an additional second web site page selectable and accessible from the second web site main page;
one or more switched home devices for providing home automation control functions within the home based upon an on/off control input, each switched home device having an associated device page provided as an additional second web site page which is selectable from the second web site main page;
a first controller interfaced to the gateway and coupled to the smart home devices, the first controller providing bi-directional communication routing of an information packet between the gateway and a home device in accordance with a selection made by a user through the home automation GUI of the first web site and the main page of the second web site; and
a second controller interfaced to the gateway and coupled to the switched home devices for communication therewith, the second controller applying a control input to a switched home device in accordance with a selection made by a user through the home automation GUI of the first web site and the main page of the second web site.

6. The system of claim 5 wherein the switched home devices are relay-controlled devices.

7. The system of claim 5 wherein the switched home devices are selected from a group consisting of lighting circuits and electrical outlets.

8. A system for home automation control wherein access to devices installed within the home is provided through an internet connection with a web server facility, comprising:
an internet connection with a web server facility on the internet;
a gateway at the home having a local web server communicating with the web server facility through a broadband internet connection, the gateway including a web communicator to authenticate information packets sent from the web server facility and a translator that evaluates authenticated information packets from the web communicator;
one or more home devices for providing home automation control functions within the home; and
a controller interfaced to the translator of the gateway and coupled to the home devices, the controller routing an information packet to a home device in accordance with an identification of an authenticated web server facility information packet and an identified home device.

9. The system of claim 8 wherein the web server facility is a utility company.

10. The system of claim 9 wherein the home device comprises a digital utility meter.

11. The system of claim 10 wherein the web communicator operates to provide bi-directional communication of data packets between the home device and the web server facility including a data packet sent to the web server facility and containing a reading of the digital utility meter.

12. The system of claim 10 wherein the web server facility sends information packets provided through the controller to the digital utility meter that permits the web server facility to have control access to the meter.

13. The system of claim 10 wherein the communication link between the controller and the gateway is an interrogated connection type involving access to a digital utility meter on an interval basis.

14. A system for home automation control wherein a user at a remote location away from a home is provided with access to devices installed within the home through an internet connection, comprising:
a browser internet connection to a web server having an associated web site with a main page providing a home automation graphical user interface (GUI) identifying home automation control functions;
a gateway at the home communicating with the web server, the gateway including:
a local web server providing a local IP address and having an associated local web site with a main page including links to additional local web site pages,
a web communicator to accept and authenticate information packets sent from the remote web server; and
a translator to evaluate authenticated information packets from the web communicator for routing to a designated destination;
one or more home devices for providing home automation control functions within the home, each home device having an associated device page provided as an additional local web site page selectable from the local web site main page; and
a controller interfaced to the gateway translator and coupled to the home devices, the controller applying control data within an information packet from the translator to a home device in accordance with a selection made by a user through the home automation GUI of the remote web site and the main page of the local web site.

15. The system of claim 14 further comprising a personal computer network connected to the gateway to make the files residing on a personal computer connected to the network accessible by the user through the browser internet connection to the remote web server.

16. A system for home automation control wherein a user at a remote location away from a home is provided with access to devices installed within the home through an internet connection, comprising:
a browser internet connection to a web server having an associated web site with a main page providing a home automation graphical user interface (GUI) identifying home automation control functions;
a gateway at the home communicating with the web server, the gateway including:
a local web server providing a local IP address and having an associated local web site with a main page including links to additional local web site pages,
a web communicator to accept and authenticate information packets sent to the gateway from the remote web server,
a translator to evaluate authenticated information packets passed from the web communicator over a local path for routing to a designated destination,
an emulator taking data specific to a home device from the translator and presents it to the additional local web site page associated with that specific home device; and
one or more home devices for providing home automation control functions within the home, each home device having an associated device page provided as an additional local web site page selectable from the local web site main page; and
a controller interfaced to the gateway translator and coupled to the home devices, the controller applying control data within an information packet from the translator to a home device in accordance with a selection made by a user through the home automation GUI of the remote web site and the main page of the local web site.
